(19) United States
(12) Patent Application Publication
(10) Pub. No.: US 2006/0076432 A1
(43) Pub. Date: Apr. 13, 2006

(54) Device and process for determining the freezing point of cleaning fluid

(75) Inventors: Martin Haueis, Gaertringen (DE); Rainer Maeckel, Koenigswinter (DE); Bernd Seiler, Stuttgart (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 11/109,790

(22) Filed: Apr. 20, 2005

(30) Foreign Application Priority Data
Apr. 21, 2004 (DE) 10 2004 019 147.6

(51) Int. Cl. A01G 27/00; B05B 7/16; B05B 1/10; B05B 1/24

(52) U.S. Cl. 239/284.1; 239/284.2; 239/67; 239/128

(57) ABSTRACT

A device and a method for determining the freezing point of a washer fluid with a heater for heating the washer fluid. The invention provides a temperature sensor, which provides continuous electric signals, which represent the current temperature values of the washer fluid, and an analyzing and controlling unit, which ascertains the temperature behavior of the washer fluid from the signals and determines the characteristic values of the washer fluid from the ascertained temperature behavior.

This application claims the priority of German Patent Application No. 10 2004 019 147.6, filed Apr. 21, 2004, the disclosure of which is expressly incorporated by reference herein.

### BACKGROUND AND SUMMARY OF THE INVENTION

The invention relates to a device for determining the freezing point of washer fluid.

At low temperatures the washer fluid in windshield and/or headlight washer systems in a vehicle can freeze. To prevent this, not only water but also antifreeze are normally added to the washer fluid, for example in the form of ethanol. Therefore, the freezing point of the washer fluid is determined from the mixing ratio of the components, contained in the washer fluid. If only water is added to an existing mixture, then the freezing point rises. This can lead to the washer fluid inside the washer system freezing and having a negative impact on the function of the windshield and/or headlight washer system in the vehicle. Thus, depending on the weather situation, the non-availability of the washer fluid can result in considerable sight obstruction or in the case of a headlight washer system in a glare of the on-coming traffic.

To prevent the washer fluid from freezing, the freezing point of the washer fluid is usually determined and, if necessary, lowered by adding antifreeze.

For the purpose of determining the freezing point of the washer fluid in conventional systems and with conventional methods, the density of the washer fluid is measured. This can be done, for example, with a density measuring spindle at a gas station or in a shop.

DE 37 34 130 A1 describes a windshield washer system for a motor vehicle, where the mixing ratio of water to antifreeze in the washer fluid is changed as a function of the outside temperature; and thus the freezing point of the washer fluid is adjusted to the outside temperature. In so doing, the freezing point of the washer fluid is determined automatically by means of a density measuring device, disposed in a mixing chamber of the washer system.

DE 43 16 981 C2 describes a windshield washer system for a motor vehicle with an evaporator, with which the mixing ratio of the washer fluid is changed as function of the outside temperature; and thus the freezing point of the washer fluid can be adjusted to the outside temperature. The freezing point of the washer fluid is determined here by a concentration measuring device, taking into consideration the different densities of the base fluid and the antifreeze.

The object of the invention is to provide a low cost device for determining the freezing point of a washer fluid and to provide an associated method for determining the freezing point.

The invention solves this problem by providing a device for determining the freezing point of a washer fluid and by a method for determining the freezing point of a washer fluid.

Advantageous embodiments and further developments of the invention are disclosed in the dependent claims.

According to the invention, the device for determining the freezing point of a washer fluid comprises a temperature sensor, which provides electric signals, which represent the current temperature values of the washer fluid, and an analyzing and controlling unit, which ascertains the temperature behavior of the washer fluid from the signals and determines the characteristic values of the washer fluid from the ascertained temperature behavior.

Compared to the density measurement, the determination of the characteristic values of the washer fluid by ascertaining the temperature behavior of the washer fluid with the temperature sensor is less susceptible to failure and less expensive to realize, because no moveable parts are required. In addition, the electric signals make it possible to analyze electronic data without an additional transducer. The inventive device for determining the freezing point of the washer fluid can be integrated in an advantageous way simply into the existing fluid level sensors for fluid containers with an electric output signal, thus expanding the functional range of the electric fluid level sensors to temperatures <−5° C.

In the design of the device for determining the freezing point of a washer fluid the analyzing and controlling unit ascertains the current temperature value from the electric signals and calculates the temperature changes between at least two temperature values, ascertained in succession, and evaluates them.

In another design of the device for determining the freezing point, the analyzing and controlling unit detects, in analyzing the temperature changes, a phase transition of the washer fluid from liquid to gaseous, when the temperature values and the calculated temperature changes exhibit a specified first variation in time, which is characterized for example by an initial slow rise in the temperature in the observed time period until the phase transition of the washer fluid is reached and then by a sudden steep rise at the phase transition of the washer fluid.

At a detected phase transition of the washer fluid, the analyzing and controlling unit ascertains the associated temperature value, which is equivalent to the boiling point of the washer fluid, and determines by means of the ascertained temperature value the mixing ratio and/or the freezing point of the washer fluid. The freezing point of the washer fluid is characterized in essence by the mixing ratio of the water to the antifreeze. Since the boiling point of water is 100° C., and the boiling point of the antifreeze, for example ethanol, is 78° C., the boiling point of the mixture falls between these two limit values as a function of the mixing ratio. The mixing ratio of the washer fluid and/or the associated freezing point can be ascertained from the ascertained boiling point, for example, by a comparison with the stored parameter curves.

In addition or as an alternative, the analyzing and controlling unit detects during the analysis process a limit fluid level of the washer fluid in a container, when the temperature values and the calculated temperature changes exhibit a specified second variation in time, which is characterized, for example, by a steep increase in the temperature values over the entire observed period. That is, the temperature increases significantly upon activation of the device.

In the design of the device for determining the freezing point, the heater and the temperature sensor are designed as a module that is immersed in the washer fluid.

The module is designed, for example, as a variable linear resistor, which is driven with a voltage and/or a current and the resistance value of which changes as a function of the temperature.

The analyzing and controlling unit determines continuously a current resistance value of the linear resistor by, for example, a voltage and/or current measurement, where the current resistance value represents the current temperature of the washer fluid.

By means of the inventive method for determining the freezing point of the washer fluid, the washer fluid is heated; the temperature behavior of the washer fluid is ascertained; and the characteristic values of the washer fluid are determined from the ascertained temperature behavior, for example, the boiling point of the washer fluid, from which the mixing ratio and the freezing point of the washer fluid can be derived, and/or a limit fluid level of the washer fluid in a container.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic drawing of a device for determining the freezing point of a washer fluid; and

FIG. 2 is a graph of the boiling temperature of a mixture of water and ethanol at 1 Atm.

### DETAILED DESCRIPTION OF THE DRAWINGS

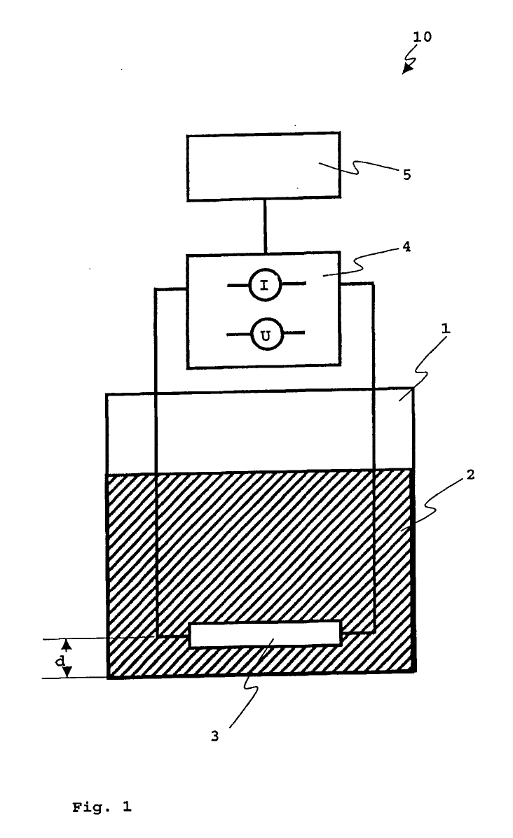

As evident from FIG. 1, the device for determining the freezing point 10 of a washer fluid 2 comprises an analyzing and controlling unit 4, a heater and a temperature sensor. The heater and the temperature sensor in the illustrated embodiment are designed as a module 3, which is immersed in the washer fluid 2, in the form of a variable linear resistor 3, the resistance value of which changes as a function of the temperature. The analyzing and controlling unit 4 drives the resistor 3 with a voltage U and a current I, so that the resistor 3 heats the washer fluid 2 locally in its environment and ascertains a current resistance value by measuring the supply voltage U and/or the flowing current I. From the measured current resistance value the analyzing and controlling unit 4 ascertains the current temperature value of the washer fluid 2 in the environment of the immersed resistor 3 and calculates the temperature changes between at least two temperature values, ascertained in succession, and analyzes the variation in time of this temperature change for the purpose of determining the characteristic values of the washer fluid 2.

The heating up of the resistor 3 depends on the energy that is supplied and the energy that is dissipated. The dependency of the resistance value is described by the equation R_{(ΔT)}=ρ₁*LA*(1+TK_{ρ}*ΔT), where p₁ stands for the specific linear resistance; LA, the geometric factor for the line path; TK_{ρ}, the temperature coefficient; and ΔT, the temperature difference.

Since the resistor 3 is immersed in the washer fluid, the temperature of the resistor 3 rises only slowly due to the energy, delivered to the washer fluid 2, so that upon activation of the device for determining the freezing point 10, the temperature of the resistor 3 and thus the washer fluid 2 increases only slowly in the environment of the resistor 3. If there is a phase change of the washer fluid 2 from liquid to gaseous, i.e. the boiling point of the washer fluid 2 is reached, at the surface of the resistor 3, then the heat dissipation to the resistor 3 decreases significantly and the resistor 3 heats up significantly faster as the power is fed in continuously, so that there is a sharp increase in temperature. From this temperature variation in time, which is characterized by an initially slow increase in temperature, followed by a sudden sharp increase in temperature, the boiling point of the washer fluid can be determined.

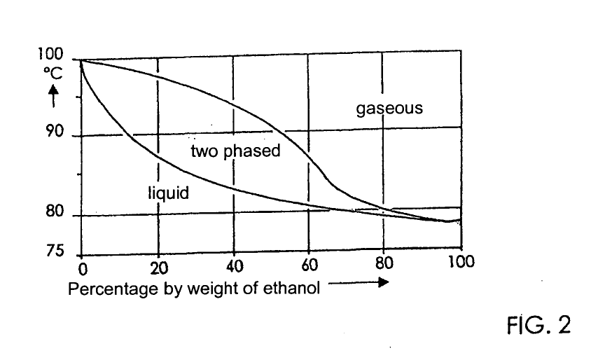

The typical composition of the washer fluid 2 for the winter contains 50-90% ethanol. The washer fluid 2 for the summer differs from the washer fluid 2 for the winter in that up to approximately 10% surfactants, like isotridecanolethoxylate, sodium laurylethersulfate and/or alkanesulfonate, are added to the washer fluid 2. However, the freezing point of the washer fluid 2 is characterized in essence by the mixing ratio of water to ethanol. Since the boiling point of water is 100° C. and the boiling point of ethanol is 78° C., the boiling point of the washer fluid 2 falls between these two limit values as a function of the mixing ratio. FIG. 2 shows a graph of the relationship between the boiling temperature and the mixing ratio of the washer fluid 2. Thus, the associated mixing ratio of the washer fluid 2 and/or the freezing point of the washer fluid 2 can be determined from the temperature value, ascertained at the phase transition of the washer fluid 2, because the mixing ratio and thus the freezing point of the washer fluid correlates to the boiling point, as shown in FIG. 2.

As an alternative or in addition, the resistor 3 can be used as a limit switch for the fluid level if the resistor is skillfully positioned inside the container 1. Said limit switch shows that washer fluid 2 should be added. If the fluid level drops below a level marked d, then a falling short of the limit value is detected, because the heat dissipation at the surface of the resistor 3 into the air is significantly less than inside the washer fluid 2. If upon activation of the device the resistor 3 is not immersed in the washer fluid 2, because the fluid level is too low, then the temperature increases sharply as a function of time at constant supply of electric power in the whole period observed. The temperature increase is significantly higher than if the resistor 3 is immersed in the washer fluid 2. The temperature variation in time differs from the phase transition of the washer fluid 2 in that the temperature already exhibits a sharp increase upon activation of the device 10.

The device 10 and/or the method for determining the freezing point can be activated, if desired, manually or automatically at predetermined times or situations. Thus, the device can be activated, for example, after every vehicle start, after filling the container 1 with washer fluid 2, after a completed washing process, i.e. after removal of the washer fluid 2 from the container 1, at the winter fitness checkup of the vehicle, during servicing, when filling up with gasoline, etc. The information about the instantaneous mixing ratio of the washer fluid 2 and the correlating freezing point can be indicated by a vehicle-sided indicating unit 5. In addition, a warning can be emitted, when a currently ascertained outside temperature can result in the washer fluid 2 freezing. In addition, when the limit fluid level d is exceeded or falls short, the indicating unit 5 can emit a warning signal.

In the illustrated embodiment the temperature sensor and the heater are disposed inside the supply container 1 for the washer fluid 2. As an alternative, the temperature sensor and the heater can be arranged at other module locations inside a washer system, for example in the line system or at the outflow nozzles.

Owing to the inventive device, based on the analysis of the temperature behavior of the washer fluid, for determining the freezing point of the washer fluid, characteristic values of the washer fluid can be determined in an advantageous way by analyzing electric signals. Thus, the freezing point and/or the limit fluid level of the washer fluid can be ascertained inexpensively and is less susceptible to failures than in conventional devices and with conventional methods.

1-14. (canceled)

15. A device for determining the freezing point of a washer fluid with
a heater for heating the washer fluid characterized by a temperature sensor, which provides electric signals, which represent the current temperature values of the washer fluid, and
an analyzing and controlling unit, which ascertains the temperature behavior of the washer fluid from the signals and determines the characteristic values of the washer fluid from the ascertained temperature behavior.

16. A device as claimed in claim 1, wherein the analyzing and controlling unit ascertains the current temperature value of the washer fluid from the signals and calculates the temperature changes between at least two temperature values, ascertained in succession, and evaluates them.

17. A device as claimed in claim 2, wherein in the analysis process the analyzing and controlling unit detects a phase transition of the washer fluid from liquid to gaseous, when the calculated temperature changes exhibit a specified first variation in time.

18. A device as claimed in claim 3, wherein at the phase transition of the washer fluid the analyzing and controlling unit ascertains an associated temperature value and determines the mixing ratio and/or the freezing point of the washer fluid from this ascertained temperature value.

19. A device as claimed in claim 2, wherein during the analysis process the analyzing and controlling unit detects a limit fluid level of the washer fluid in a container, when the calculated temperature changes exhibit a specified second variation in time.

20. A device as claimed in claim 1, wherein the heater and the temperature sensor are designed as a module that is immersed in the washer fluid.

21. A device as claimed in claim 6, wherein the module is designed as a variable linear resistor, which is driven with a voltage and/or a current and the resistance value of which changes as a function of the temperature.

22. A device as claimed in claim 7, wherein the analyzing and controlling unit determines continuously a current resistance value of the linear resistor by a voltage and/or current measurement, where the current resistance value represents the current temperature of the washer fluid.

23. A method for determining the freezing point of washer fluid, in which process the washer fluid is heated,
wherein
the temperature behavior of the washer fluid is ascertained; and
the characteristic values of the washer fluid are determined from the ascertained temperature behavior.

24. A method as claimed in claim 9, wherein to ascertain the temperature behavior the temperature of the washer fluid is ascertained and the temperature changes between two successively ascertained temperature values are calculated and evaluated.

25. A method as claimed in claim 9, wherein in the analysis process a phase transition of the washer fluid from liquid to gaseous is detected and an associated temperature value is determined, when the temperature changes exhibit a specified first variation in time.

26. A method as claimed in claim 11, wherein a mixing ratio and/or the freezing point of the washer fluid is/are ascertained from the determined temperature value.

27. A method as claimed in claim 9, wherein in the analysis process a limit fluid level of the washer fluid in a container is detected and reported, when the temperature changes exhibit a specified second variation in time.

28. A method as claimed in claim 9, wherein to ascertain the temperature behavior of the washer fluid, at least one electric parameter is ascertained.
